(19) United States
(12) Patent Application Publication
(10) Pub. No.: US 2025/0257848 A1
(43) Pub. Date: Aug. 14, 2025

(54) OPERATION MANIFOLD FOR A VEHICLE PRESSURIZED FLUID STORAGE AND DISTRIBUTION ASSEMBLY

(71) Applicant: Plastic Omnium New Energies France, Lyon (FR)

(72) Inventors: Christian BOPWA MUNTU, Bruxelles (BE); Lorena BARBOSA, Bruxelles (BE); Christoph FASSMANN, Bruxelles (BE)

(73) Assignee: Plastic Omnium New Energies France, Lyon (FR)

(21) Appl. No.: 18/875,511

(22) PCT Filed: Jun. 23, 2023
(86) PCT No.: PCT/EP2023/067117

§ 371 Date: Dec. 16, 2024

(30) Foreign Application Priority Data
Jun. 23, 2022 (FR) FR2206215

(51) Int. Cl. F17C 7/00; F17C 5/06

(52) U.S. Cl. CPC F17C 7/00; F17C 5/06; F17C 2205/0142; F17C 2205/0146; F17C 2205/0329; F17C 2205/0332; F17C 2205/0335; F17C 2221/012; F17C 2223/0123; F17C 2250/043; F17C 2250/0439; F17C 2270/0184

(57) ABSTRACT

An operation manifold is for a vehicle pressurized-fluid storage and distribution assembly that includes a plurality of pressurized-fluid tanks. The manifold includes a body having a plurality of communication openings to be in fluidic communication with a tank, a distribution line for distributing fluid stored in the tanks and which is formed in the body and arranged to be in fluidic communication with the tanks via an electrically operated valve and a manual valve, and a tank filling line formed in the body and arranged to be in fluidic communication with the tanks. The manual valve is also used to ensure fluidic communication between the tank filling line and the tanks

### TECHNICAL FIELD OF THE INVENTION

The invention relates to an operation manifold for a vehicle pressurized-fluid storage and distribution assembly. The invention also relates to a vehicle pressurized-fluid storage and distribution assembly comprising an operation manifold according to the invention, and to a vehicle, preferably a motor vehicle, comprising such an assembly. Finally, the invention relates to a method of distributing pressurized fluid for a vehicle, a method of filling pressurized-fluid tanks and a method of discharging fluid stored in pressurized-fluid tanks by means of an operation manifold according to the invention.

### BACKGROUND ART

Operation manifolds for a vehicle pressurized-fluid storage and distribution assembly are already known in the prior art, for example from document WO2021/110707. In particular, these operation manifolds are used to help manage the circulation of fluids, especially gases, between several pressurized-fluid tanks. Such a plurality of tanks is used in particular for motor vehicles, for example to store pressurized dihydrogen. In fact, the use of this plurality of reduced-capacity tanks makes it possible to increase the on-board storage capacity of the vehicle, whereas the available space is not compatible with the integration of a single large-capacity storage tank. However, the use of several tanks requires the use of an operation manifold and several functional members, such as temperature sensors, pressure sensors or valves in order to manage the circulation of fluids between the tanks and the rest of the vehicle, in particular for their filling, distribution and/or discharging of fluids. Thus, even if the spatial footprint is reduced by virtue of the use of a plurality of reduced-volume tanks, the footprint of the storage assembly comprising the tanks, the operation manifold and the functional members may be relatively complex to manage on the vehicle. In addition, assembling several functional members on the operation manifold entails an additional cost when assembling the storage assembly on the vehicle.

Other examples of prior art operation manifolds are known from document WO 2021/220128.

### SUMMARY OF THE INVENTION

The aim of the invention is notably to simply and economically reduce the spatial footprint of a vehicle pressurized-fluid storage and distribution assembly, comprising an operation manifold.

To this end, the object of the invention is an operation manifold for a vehicle pressurized-fluid storage and distribution assembly, the assembly comprising a plurality of pressurized-fluid tanks, the operation manifold comprising:
a body having a plurality of communication openings, each communication opening being configured to be in fluidic communication with a tank,
an electrically operated valve,
a manual valve,
a distribution line for distributing fluid stored in the tanks, the fluid distribution line being formed in the body and being configured to be in fluidic communication with the tanks via the electrically operated valve and the manual valve, the fluid distribution line comprising a first check valve to prevent fluid from flowing in a first direction towards the tanks and to allow fluid to flow in a second direction, opposite to the first direction,
a tank filling line, formed in the body and configured to be in fluidic communication with the tanks, the tank filling line comprising a second check valve designed to allow fluid to flow in the first direction towards the tanks and to prevent fluid from flowing in an opposite direction, characterized in that the manual valve is also used to provide fluidic communication between the tank filling line and the tanks.

In this way, a fluid distribution line and a fluid filling line are proposed, which are distinct at least over one portion and which share the same manual valve to ensure their fluidic communication with the tanks. The result is a reduction in the number of functional members used, in particular the number of manual valves used, which not only saves on the manufacture of the operation manifold, but also reduces the spatial footprint and weight thereof.

Furthermore, it is understood that according to the present invention, the functional members that are the electrically operated valve, the manual valve and the first and second check valves, are directly supported by the operation manifold and housed in the body thereof. Thus, the spatial footprint of the storage assembly, comprising the operation manifold, the functional members and the tanks, is reduced. In addition, assembly thereof on the vehicle is simplified, since the manifold can be simply assembled, integrating the functional members already installed, rather than having to assemble each member separately on the vehicle. Furthermore, as the functional members are carried by the operation manifold, the functions thereof can be centralized therein, avoiding the need to equip each tank with at least one of these functional members, so that the total number of functional members used can be reduced. Further, the functions integrated into the operation manifold prevent the need to fit each tank end fitting present between each tank and the operation manifold, as is the case in particular with the storage assembly described in document WO 2021/110707. This thus reduces the manufacturing cost, spatial footprint and weight of the storage assembly comprising such an operation manifold, while making it easier to use.

It is therefore understood that the operation manifold is not assimilable to communication end fittings arranged on each tank or between each tank and the operation manifold.

The distribution and filling lines are obtained, for example, by machining the body of the manifold. This is a simple, efficient and lightweight way of obtaining these distribution and filling lines.

The first and second check valves, also known as non-return valves,

ensure that the fluid flows in only one direction, thus preventing the backflow of fluid circulating in the distribution and filling lines, during fluid distribution and during tank filling respectively.

“Electrically operated valve” is understood to mean an electrically controlled valve which selectively blocks or releases the flow of fluid through a conduit, possibly via intermediate positions limiting the size of the opening of the valve. Herein, the electrically operated valve can selectively block or release the flow of fluid in the distribution line. The electrically operated valve makes it easy to manage the distribution of fluid via the distribution line by allowing or preventing the flow of fluid from the tanks to a fluid consuming member via the distribution line.

“Manual valve” is understood to mean a valve that can be controlled manually by an operator in order to block or release the flow of fluid through a conduit. Generally, the manual valve is open during normal conditions of use of the tanks, that is, during filling and distribution, therefore routine operation of the tanks. Closing the manual valve allows the pressurized tanks to be isolated, for example in order to perform maintenance operations requiring isolation of the tanks.

Pressurized-fluid tanks are for example tanks capable of storing dihydrogen under pressure, typically at a pressure of 35 MPa (350 bar), or even 70 MPa (700 bar), at ambient temperature. Tanks capable of storing natural gas under pressure (known as CNG), typically at a pressure of 20 MPa (200 bar), or even 30 MPa (300 bar), at ambient temperature are also known. “Ambient temperature” is understood to mean a temperature range of 20° C.±10° C.

“A plurality of tanks” is understood to mean at least two tanks, preferably at least five tanks, or even at least ten tanks.

In one embodiment, the body of the operation manifold is an elongated body along a main longitudinal axis between two axial ends. This configuration is particularly suited to the use of operation manifolds with several tanks aligned side by side. In this case, the communication openings are distributed along the length of the elongated body, between the two axial ends so that each is arranged opposite the respective communication end fittings of the tanks.

The invention may also comprise one or more of the following optional features, taken alone or in combination.

The operation manifold further comprises a first line for discharging fluid stored in the tanks, formed in the body of the operation manifold and designed to be in fluidic communication between the inside of the tanks and the outside, the first line for discharging fluid stored in the tanks comprising a manual discharge valve designed to allow or prevent fluidic communication between the inside of the tanks and the outside. In this way, the fluid can be easily discharged from the tanks and from the operation manifold. This is particularly advantageous for simple and safe maintenance operations on the operation manifold or on the tanks. In addition, the fact that the line for discharging fluid stored in the tank is formed in the body of the operation manifold facilitates handling and installation of the operation manifold on the tanks and on the vehicle, as well as reducing the spatial footprint thereof.

The operation manifold further comprises a second line for discharging fluid stored in the tanks, formed in the body of the operation manifold and designed to bring the inside of the tanks and the outside into fluidic communication, the second line for discharging fluid stored in the tanks comprising a first thermally-controlled pressure relief device, designed to allow or prevent fluidic communication between the inside of the tanks and the outside. The presence of the first thermo-controlled pressure relief device ensures the safety of the tanks, by allowing the fluid present therein to be discharged to the outside in the event of a risk of excess fluid pressure inside the tanks, for example in the event of a fire. Such a device is also known as a thermal and pressure relief device (TPRD). The fact that the thermo-controlled pressure relief device is integrated into the second line for discharging fluid stored in the tanks, that is, integrated into the body of the operation manifold, means that the safety function thereof can be integrated directly into the operation manifold, thus facilitating installation of the operation manifold and further reducing the spatial footprint of the operation manifold.

Preferably, the operation manifold further comprises a third line for discharging fluid stored in the tanks, formed in the body of the operation manifold and designed to be in fluidic communication between the inside of the tanks and the outside, the third line for discharging fluid stored in the tanks comprising a second thermo-controlled pressure relief device, designed to allow or prevent fluidic communication between the inside of the tanks and the outside. This thus further enhances the safety of the assembly comprising the operation manifold. In fact, by using two thermo-controlled pressure relief devices rather than just one, the detection of phenomena likely to generate a fluid overpressure inside the tanks, typically the detection of the presence of a fire in the vicinity of the tanks, is facilitated and accelerated since a larger spatial area is covered by the two thermo-controlled pressure relief devices compared with one thermo-controlled pressure relief device only.

The operation manifold further comprises a temperature sensor housed inside the body of the operation manifold and designed to measure a temperature of the fluid present in the operation manifold. The fluid temperature measurement function is therefore integrated into the operation manifold, thus making it easier to use and reducing the spatial footprint of the assembly comprising the operation manifold. In addition, this embodiment is particularly advantageous in that one common temperature sensor may be sufficient for the entire operation manifold and the tanks with which the operation manifold is associated, whereas in the prior art, several temperature sensors are used and are attached to several tanks, or even one temperature sensor is used per tank. In addition, as the temperature sensor is present in the operation manifold, it provides an accurate measurement of the temperature of the fluid present therein and therefore of the temperature of the fluid distributed, which can be advantageous as the tanks are generally better thermally insulated than the operation manifold, which has a higher heat transfer. In contrast, in the prior art, the temperature sensors used are mounted on the tanks, for example at the ends thereof, and therefore provide a measurement of the temperature of the stored fluid and are not able to provide an accurate measurement of the temperature of the distributed fluid. Preferably, at least one further temperature sensor is provided in a tank or in the immediate vicinity thereof, but not on every tank, as all the tanks are connected to each other, so only the measurement on one or a few tanks may be sufficient. It is therefore understood that the number of temperature sensors is reduced, which reduces the manufacturing and maintenance cost, as well as the weight and spatial footprint of the operation manifold.

The operation manifold further comprises a pressure sensor housed inside the body of the operation manifold and designed to measure a pressure inside the operation manifold. The fluid pressure measurement function is therefore integrated into the operation manifold, thus making it easier to use and reducing the footprint of the assembly comprising the operation manifold and tanks. In addition, a single pressure sensor is sufficient for the entire manifold and the tanks with which the manifold is associated, whereas in the prior art, several pressure sensors attached to the tanks are used. As the pressure sensor is located in the operation manifold, it provides a precise measurement of the pressure of the fluid present therein and therefore of the pressure of the distributed fluid. In contrast, in the prior art, the pressure sensors used are mounted on the tanks, for example at the end fittings thereof, and provide a measurement of the pressure of the stored fluid, without being able to provide a precise measurement of the pressure of the distributed fluid. It is also understood that the number of pressure sensors is reduced, which reduces the manufacturing and maintenance cost, as well as the weight and spatial footprint of the operation manifold.

The operation manifold further comprises at least one particle filter located upstream or downstream of the manual valve. The function of filtering particles present in the fluid is therefore integrated into the operation manifold, thus making it easier to use and reducing the spatial dimensions of the assembly comprising the operation manifold and the tanks. In addition, as the filtration function is centralized in the operation manifold, it is not necessary to provide a filter for each tank. This therefore reduces the number of filters used, which is economical and reduces the weight of the operation manifold. The filter may be located upstream or downstream of the manual valve. The upstream or downstream position is defined in relation to a direction of circulation of the fluid in the operation manifold. For example, if the filter is positioned upstream of the manual valve when the fluid flows in the filling line in the first direction towards the tanks, it will be considered to be positioned downstream of the manual valve when the fluid flows in the distribution line in the second direction, opposite to the first direction. Conversely, if the filter is positioned downstream of the manual valve when the fluid flows in the filling line in the first direction towards the tanks, it will be considered to be positioned upstream of the manual valve when the fluid flows in the distribution line in the second direction, opposite to the first direction. In a particular embodiment, the operation manifold comprises two particle filters. For example, the first filter is positioned upstream of the manual valve when the fluid flows through the operation manifold in the first direction, towards the tanks, and the second filter is positioned upstream of the manual valve when the fluid flows through the operation manifold in the second direction, opposite to the first direction.

The distribution line for distributing fluid stored in the tanks comprises a distribution opening opening into an end region of the body of the operation manifold, the filling line comprising a supply opening, distinct from the distribution opening, opening into the same end region of the operation manifold as the distribution opening. The compactness of the operation manifold is further enhanced by the fact that the conduits intended to be fluidly connected to the distribution opening and the supply opening respectively, can be grouped together in the same restricted area. It is further understood that the installation of the operation manifold is, at the same time, made easier. In one embodiment, the end region of the body of the operation manifold comprises an end face of the body and a peripheral edge face of the body, the peripheral edge face of the body extending from the end face of the body towards a first of the communication openings. The first of the communication openings corresponds to the communication opening that is spatially closest to the end face of the body. In a preferred embodiment, the body is elongated along the main longitudinal axis thereof between two axial ends, the end region corresponding to one of the two axial ends of the body.

The distribution line comprises a flow-limiting valve arranged between the electrically operated valve and the manual valve. The fluid distribution flow limiting function is therefore integrated into the operation manifold, thus making the operation manifold easier to use and reducing the footprint of the assembly comprising the operation manifold. A flow-limiting valve is also called a flow rate limiting valve.

The body of the operation manifold is integral and made of a material suitable for circulating pressurized gases, specifically a material certified for hydrogen applications, for example an aluminum or stainless steel material. The result is thus an easy-to-manufacture, compact and robust operation manifold. In particular, it is noted that the functional members of the operation manifold such as the manual valve, the electrically operated valve, the first and second check valves or the temperature or pressure sensors can be easily integrated into the body of the manifold in a particularly compact manner with, for example, few or no protruding regions outside a casing surface delimited by the body of the operation manifold. In a particular embodiment, the body of the operation manifold is elongated and has the shape of a hollow section made of metal such as aluminum or stainless steel, which are easy-to-use and resistant materials. Of course, other metals suitable for pressurized gas circulation can be used.

The invention also relates to a vehicle pressurized-fluid storage and distribution assembly, comprising an operation manifold as described above. Preferably, the assembly comprises a plurality of pressurized-fluid tanks designed to cooperate with the operation manifold in order to perform pressurized-fluid storage and distribution.

The object of the invention also relates to a vehicle, preferably a motor vehicle, comprising a pressurized-fluid storage and distribution assembly as described above. Preferably, the pressurized fluid is a pressurized gas, for example dihydrogen. This pressurized gas may, for example, be advantageously used as fuel in a fuel cell in order to generate the electricity needed to operate an electric motor of the vehicle.

The object of the invention also relates to a method of distributing pressurized fluid for a vehicle by means of an operation manifold as described above, comprising the following steps:
a) the manual valve being opened, opening the electrically operated valve, and
b) distributing fluid from the tanks to a fluid consuming member via the distribution line.

This method makes it easy to supply fluid to the fluid consuming member. For example, the fluid is a pressurized gas such as dihydrogen and the fluid consuming member is a fuel cell.

The object of the invention also relates to a method of filling pressurized-fluid tanks by means of an operation manifold as described above, comprising the following steps:
a) the manual valve being opened, closing the electrically operated valve, and
b) supplying fluid to the tanks from a supply source of this fluid via the filling line.

This method allows tanks to be easily filled from a fluid supply source.

Finally, the invention also relates to a method of discharging fluid stored in pressurized-fluid tanks by means of an operation manifold as described above, comprising the following steps:
a) closing the manual valve, and
b) opening the manual discharge valve.

This thus makes it easy to discharge the fluid present in the operation manifold and tanks in order, for example, to perform a maintenance operation.

### BRIEF DESCRIPTION OF THE FIGURES

The invention will be better understood upon reading the following description, which is provided merely as a non-limiting example and with reference to the appended drawings, wherein:

FIG. 1 is a schematic representation of a vehicle comprising a pressurized-fluid storage and distribution assembly comprising an operation manifold according to the invention;

FIG. 2 is a front view of part of the pressurized-fluid storage and distribution assembly of FIG. 1;

FIG. 3 is a schematic representation of the pressurized-fluid storage and distribution assembly of FIGS. 1 and 2;

FIG. 4A is a view from the left side, with reference to FIG. 2, of part of the fluid storage and distribution assembly of FIG. 2;

FIG. 4B is a view from the right side, with reference to FIG. 2, of the fluid storage and distribution assembly of FIG. 2;

FIG. 4C is a bottom view of the fluid storage and distribution assembly of FIG. 2;

FIG. 4D is a top view of the fluid storage and distribution assembly of FIG. 2;

FIG. 4E is a cross-sectional view along the sectional plane A-A of FIG. 2;

FIG. 4F is a cross-sectional view along the sectional plane B-B of FIG. 4E; and

FIG. 5 is a perspective view of part of a prior art pressurized-fluid storage and distribution assembly.

### DETAILED DESCRIPTION

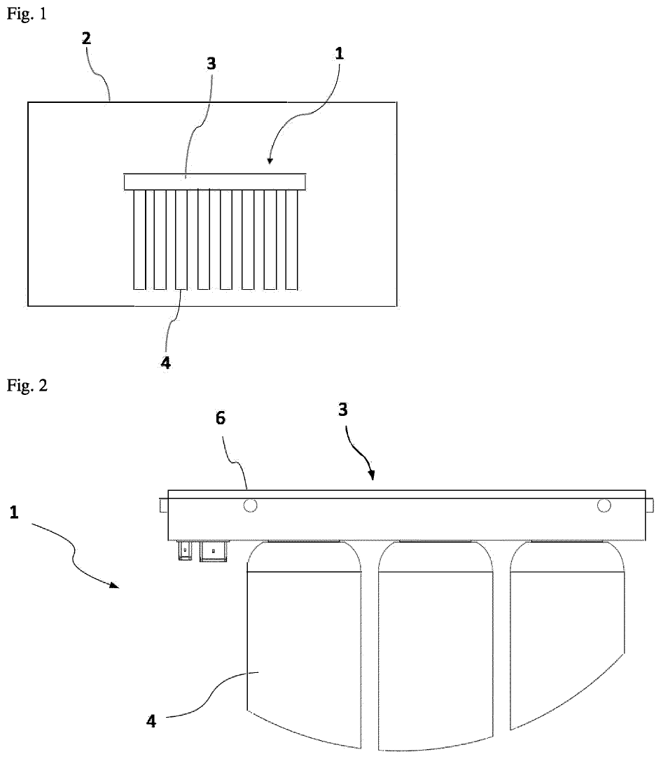

FIGS. 1 to 4F show a pressurized-fluid storage and distribution assembly 1 mounted on a motor vehicle 2 and comprising an operation manifold 3 according to the invention and a plurality of pressurized-fluid tanks 4.

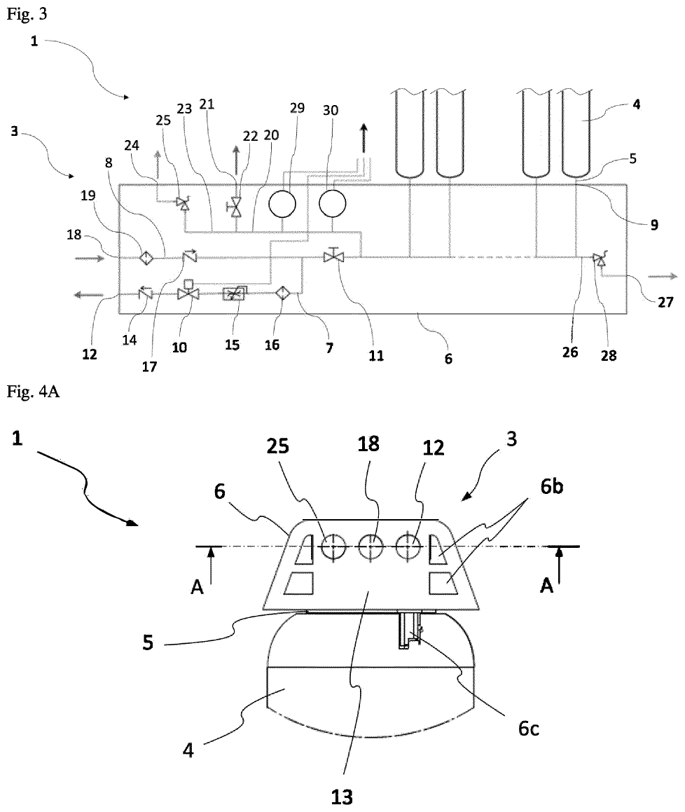

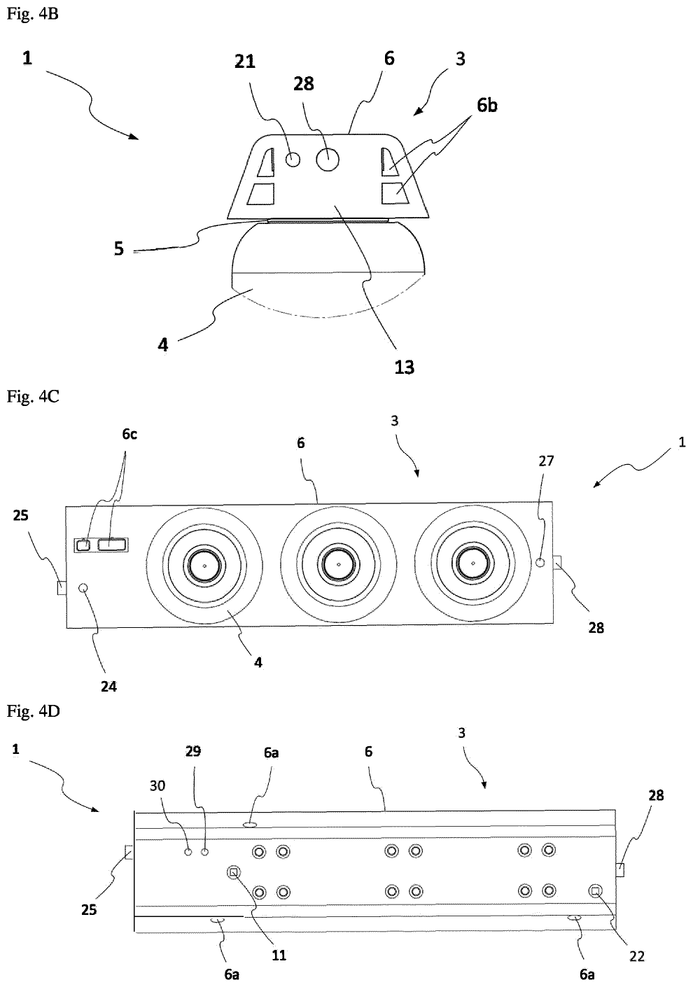

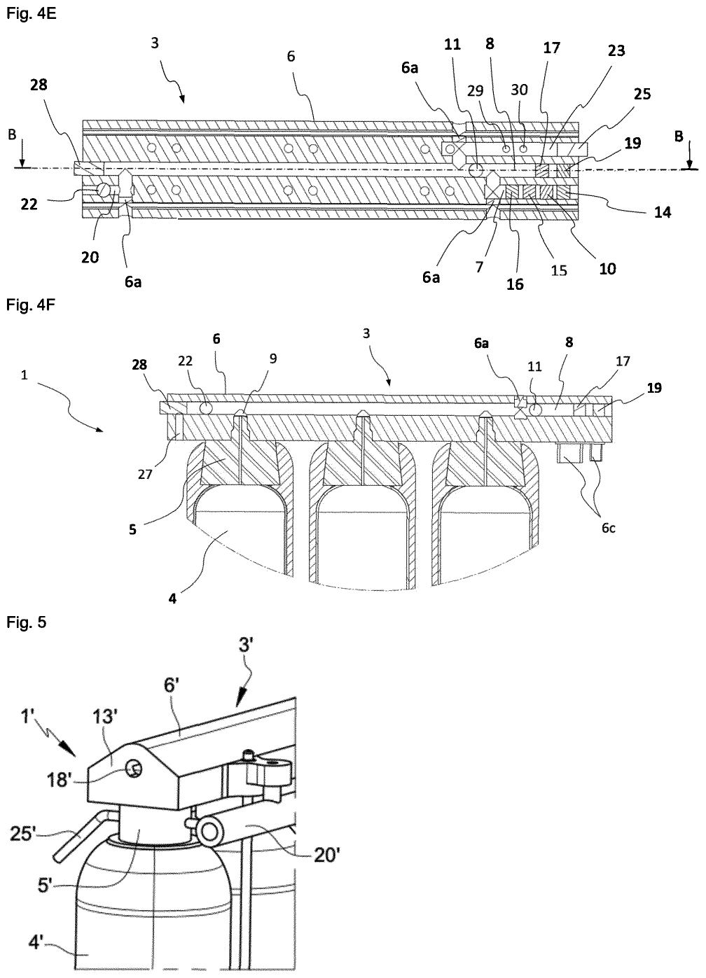

In this case, the fluid to be stored and distributed by the pressurized-fluid storage and distribution assembly 1 is a gas, for example pressurized dihydrogen. The pressurized-fluid tanks 4 are therefore tanks 4 capable of containing pressurized dihydrogen at a storage pressure of 350 bar, or even 700 bar, at ambient temperature. The pressurized-fluid tanks 4 are joined together by a supporting structure (not shown) and by the operation manifold 3. In the present embodiment, the tanks 4 are identical to each other. Each tank 4 has a substantially elongated cylindrical shape and comprises an inner casing, also known as a liner (not shown). The liner is made of polymeric material, for example, and comprises at least one neck-shaped opening. Each tank 4 further comprises an end fitting 5 on top of the neck, designed to cooperate with the operation manifold 3 in order to allow the operation manifold 3 to be attached to the tanks 4 (FIG. 4F). In other embodiments, at least one of the tanks is different from the others. In the present embodiment, the tanks 4 extend longitudinally, are arranged parallel to one another and are additionally aligned (FIGS. 1 and 2). The number of tanks 4 varies according to the embodiments, depending in particular on the desired gas storage capacity and the space available in the motor vehicle 2. Thus, the assembly 1 comprises at least three tanks, preferably at least five or even at least ten tanks, in the example more precisely, thirteen tanks (only three tanks 4 are shown in FIGS. 2 and 4A to 4F and four tanks 4 are shown in FIG. 3).

The operation manifold 3 has a generally elongated shape and notably comprises a body 6, a distribution line 7, a filling line 8 and functional members.

The body 6 of the operation manifold 3 has a generally elongated shape extending between two longitudinal ends and is integral (FIGS. 2 and 4E). It is made of a material suitable for circulating pressurized gases, in particular pressurized dihydrogen, for example an aluminum or stainless steel material. It is understood that, according to alternative versions, materials other than aluminum or stainless steel may be used, in particular metallic materials. The body 6 has a plurality of communication openings 9, each communication opening 9 being configured to be in fluidic communication with a tank 4 (FIGS. 3 and 4F). For example, the tanks 4 are screwed, snapped or clamped by their end fitting 5 onto the communication openings 9 of the operation manifold 3 in order to bring the inside of the tank 4 into fluidic communication with the communication opening 9 to which it is attached.

The line 7 for distributing the fluid stored in the tanks 4 is formed in the body 6 of the operation manifold 3 (FIGS. 3 and 4E). The distribution line 7 is configured to be in fluidic communication with the tanks 4 via an electrically operated valve 10 and a manual valve 11. The distribution line 7 comprises a distribution opening 12 which opens into an end region of the body 6 of the operation manifold 3, more particularly into an end face 13 of the body 6 of the operation manifold 3 (FIG. 4A). This distribution opening 12 is designed to be fluidly connected to a conduit for supplying fluid to a fluid consuming member (not shown).

The electrically operated valve 10 is an electrically controlled valve which selectively prevents or allows fluid to flow through the distribution line 7.

Thus, when closed, the electrically operated valve 10 prevents the circulation of fluid in the distribution line 7, and thus prevents the distribution of fluid to the fluid consuming member. When open, the electrically operated valve 10 allows fluid to flow into the distribution line 7, and therefore allows fluid to be distributed to the fluid consuming member. The manual valve 11 performs the same function, namely to prevent or allow the flow of fluid into the distribution line 7, with the difference that it is not controlled electrically but manually, for example by an operator. Thus, the fluid can flow through the distribution line 7 from the tanks 4 and to the element consuming this fluid only when both the electrically operated valve 10 and the manual valve 11 are both open. In this case, the fluid is a gas, dihydrogen, and the device for consuming this fluid is a fuel cell capable of using dihydrogen as a fuel in order to generate electricity. In other embodiments, the fluid may be of a different nature, for example the fluid may be another gas other than dihydrogen.

The distribution line 7 also comprises a first check valve 14 designed to prevent fluid from flowing in a first direction through the distribution line 7 towards the tanks 4 and to allow fluid to flow in a second direction through the distribution line 7, opposite to the first direction.

The distribution line 7 further comprises a flow-limiting valve 15 arranged between the electrically operated valve 10 and the manual valve 11 (FIGS. 3 and 4E). The flow-limiting valve 15 regulates the flow of fluid being distributed to the fluid consuming member.

The distribution line 7 comprises a first particle filter 16 arranged between the manual valve 11 and the flow-limiting valve 15 (FIGS. 3 and 4E). In other words, the first particle filter 16 is arranged downstream of the manual valve 11 when the fluid flows through the distribution line 7 in the second direction, from the tanks 4 to the distribution opening 12 of the distribution line 7. The characteristics of the first filter 16 are selected based on the particles to be filtered and on the level of purity required of the fluid distributed by the fluid storage and distribution assembly 1 to the member consuming this fluid. In one variant (not shown), the first particle filter 16 is arranged between the manual valve 11 and the tanks 4. In other words, according to this variant, the first particle filter 16 is arranged upstream of the manual valve 11 when the fluid flows through the distribution line 7 in the second direction, from the tanks 4 to the distribution opening 12 of the distribution line 7.

The filling line 8 of the tanks 4 is itself also formed in the body 6 of the operation manifold 3 (FIGS. 3 and 4E). The filling line 8 of the tanks 4 is configured to be in fluidic communication with the tanks 4. It comprises a second check valve 17 designed to allow fluid to flow through the filling line 8 of the tanks 4 in the first direction towards the tanks 4 and to prevent fluid from flowing through the tank filling line 8 in a direction opposite to the first direction.

The manual valve 11 used in the distribution line 7 is also used to ensure fluidic communication between the filling line 8 of the tanks 4 and the tanks 4 (FIGS. 3 and 4E). The use of a single manual valve 11 for both the distribution line 7 and the filling line 8 of the tanks 4 is advantageous in that it reduces the number of manual valves 11 used, which is economical and reduces the spatial footprint of the operation manifold 3. It should also be noted that the fact that this manual valve 11 is present in the operation manifold 3 rather than, for example, in the tank end fittings 5, makes it possible to centralize the function of this manual valve 11 in the operation manifold 3 and therefore make the fluid storage and distribution assembly 1 easier to use.

The filling line 8 of the tanks 4 comprises a supply opening 18 opening into the same end region of the operation manifold 3 as that into which the distribution opening 12 of the distribution line 7 opens (FIG. 4A). More specifically, the supply opening 18 opens into the same end face 13 of the operation manifold 3 as that into which the distribution opening 12 opens. Thus, installation of the operation manifold 3 is facilitated and it is possible to optimize the placement of the conduits for the flow of fluid in the vehicle 2, thus reducing the spatial footprint of the operation manifold 3. The supply opening 18 is configured to be fluidly connected to a fluid supply source. In this case, the fluid supply source is a source of pressurized dihydrogen.

The filling line 8 of the tanks 4 comprises a second particle filter 19. In this case, the second particle filter 19 is arranged between the supply opening 18 and the second check valve 17 (FIGS. 3 and 4E). According to alternatives (not shown), the second particle filter 19 may be located elsewhere in the filling line 8 of the tanks 4, for example between the second check valve 17 and the manual valve 11. The second particle filter 19 removes some of the impurities that may be present in the fluid when it is introduced into the operation manifold 3.

The operation manifold 3 further comprises a first line 20 for discharging fluid stored in the tanks 4 (FIGS. 3 and 4E). The first line 20 for discharging fluid stored in the tanks is formed in the body 6 of the operation manifold 3 and is designed to bring the inside of the tanks 4 into fluidic communication with the outside. The first line 20 for discharging fluid stored in the tank has a first discharge opening 21 which opens onto the surface of the body 6 of the operation manifold 3. In the present case, the first discharge opening 21 opens into the end face 13 of the body 6 of the operation manifold 3 which is opposite the end face 13 into which the distribution opening 12 and the supply opening 18 open (FIG. 4B). In other embodiments (not shown), the first discharge opening 21 may open elsewhere, for example in the end face 13 into which the distribution opening 12 and the supply opening 18 open. The first line 20 for discharging fluid stored in the tanks 4 comprises a manual discharge valve 22 designed to prevent or allow fluidic communication between the inside of the tanks 4 and the outside. In this way, if an operator wishes to carry out a maintenance operation on the fluid storage and distribution assembly 2 requiring the absence of fluid, he can easily discharge the fluid by opening the manual discharge valve 22 so that the fluid, herein dihydrogen, present in the tanks 4 and in the operation manifold 3 is discharged to the outside via the first line 20 for discharging fluid present in the tanks 4 and through the first discharge opening 21.

The operation manifold 3 further comprises a second line 23 for discharging fluid stored in the tanks 4 (FIGS. 3 and 4E). The second line 23 for discharging fluid stored in the tanks 4 is provided in the body 6 of the operation manifold 3 and is designed to bring the inside of the tanks 4 into fluidic communication with the outside. The second line 23 for discharging fluid stored in the tanks 4 has a second discharge opening 24 which opens onto the surface of the body 6 of the operation manifold 3. The second line 23 for discharging fluid stored in the tanks 4 comprises a first thermo-controlled pressure relief device 25, also known by its acronym TPRD. The first thermo-controlled pressure relief device 25 is designed to allow or prevent fluidic communication between the inside of the tanks 4 and the outside. Typically, the thermo-controlled pressure relief device 25 prevents fluidic communication between the inside of the tanks 4 and the outside via the second discharge line 23 when no abnormal heat source is present, typically in the absence of fire. In the event of a fire, the thermo-controlled pressure relief device 25 is structurally modified in order to allow fluidic communication between the inside of the tanks 4 and the outside via the second discharge line 23. This communication allows the fluid present in the tanks 4 and the operation manifold 3 to be discharged to the outside via the second discharge line 23 and through the second discharge opening 24. Such a thermo-controlled decompression device 25 improves the safety of the fluid storage and distribution assembly 1 by preventing the occurrence of an overpressure inside the tanks 4 which could cause them to explode. In the present case, the second discharge opening 24 opens into a lower face of the body 6 of the operation manifold 3, at the axial end of the body 6 which comprises the end face 13 into which the distribution opening 12 and the supply opening 18 open (FIG. 4C). In other embodiments (not shown), the second discharge opening 24 may open elsewhere, for example at the end face 13 of the body 6 of the operation manifold 3 into which the distribution opening 12 and the supply opening 18 open.

In the present case, the operation manifold 3 further comprises a third line 26 for discharging fluid stored in the tanks 4. The third line 26 for discharging fluid stored in the tanks 4 is formed in the body 6 of the operation manifold 3 and is designed to bring the inside of the tanks 4 into fluidic communication with the outside. The third line 26 for discharging fluid stored in the tanks 4 has a third discharge opening 27 which opens onto the surface of the body 6 of the operation manifold 3. The third line 26 for discharging fluid stored in the tanks 4 comprises a second thermo-controlled pressure relief device 28, also known by its acronym TPRD. Like the first thermo-controlled pressure relief device 25, the second thermo-controlled pressure relief device 28 is designed to allow or prevent fluidic communication between the inside of the tanks 4 and the outside. The presence of this second thermo-controlled pressure relief device 28 further enhances the safety of the pressurized-fluid storage and distribution assembly 1 by increasing the detection area of any fire. In the present case, the third discharge opening 27 opens into the lower face of the body 6 of the operation manifold 3, at the axial end opposite that into which the second discharge opening 24 opens (FIG. 4C). This is therefore the axial end comprising the end face 13 into which the first discharge opening 21 opens. In other embodiments (not shown), the third discharge opening 27 may be provided elsewhere, for example in the end face 13 into which the first discharge opening 21 opens.

As FIG. 3 is schematic, it does not necessarily show the exact locations of the various functional members in relation to each other, unless otherwise indicated, for the sake of simplicity. In particular, it can be seen that the first discharge opening 21, the second discharge opening 24 and the third discharge opening 27 are positioned relative to one another in positions that do not correspond to those shown in FIG. 4E.

The operation manifold 3 further comprises caps 6a configured to hermetically seal openings formed in the body 6 of the operation manifold 3, which have been machined notably to create the various lines (FIGS. 4D and 4E), from the fluid intended to flow through the operation manifold 3. This is thus a simple and advantageous way of preventing the fluid circulating in the operation manifold 3 from escaping to the outside.

The operation manifold 3 further comprises a temperature sensor 29 housed inside the body 6 of the operation manifold 3 for measuring a temperature of the fluid present in the operation manifold 3. This temperature sensor 29 can thus measure the temperature of the distributed fluid, that is, in the present embodiment, the temperature of the dihydrogen supplied to the fuel cell.

The operation manifold 3 also comprises a pressure sensor 30 housed inside the body 6 of the operation manifold and designed to measure a pressure inside the operation manifold 3. It is understood that it is advantageous to use a single pressure sensor 30 to measure the pressure of the fluid in the manifold rather than using several pressure sensors to measure the pressure of the fluid in the tanks.

The measurements made by the temperature sensor 29 and the pressure sensor 30 are transmitted to an electronic control unit (not shown) capable of processing this information and, if necessary, commanding actions to correct the temperature and/or the pressure if these parameters are not within a predetermined value range. The temperature sensor 29, the pressure sensor 30 and the electrically operated valve 10 are connected to the electronic control unit via an electronic connector 6c carried by the body 6 of the operation manifold 3 (FIGS. 4A, 4C and 4F). In the embodiment shown, the electronic connector 6c is carried by the lower face of the body 6 of the operation manifold 3.

Recesses 6b have been made in the body 6 of the operation manifold 3 (FIGS. 4A and 4B). In the present case, each recess 6b passes axially through the body 6 of the operation manifold 3 and opens out at the two end faces 13 of the body 6. These recesses 6b advantageously reduce the weight of the operation manifold 3.

It should be noted that the operation manifold 3 according to the invention is particularly advantageous in that it integrates a large number of functional members, such as the manual valve 11, the electrically operated valve 10, the manual discharge valve 22, the temperature sensor 29, the pressure sensor 30, the first thermo-controlled pressure relief device 25 or else the second thermo-controlled pressure relief device 28. These functions are therefore centralized in the operation manifold 3, optimizing the number of functional members used and simplifying the installation and the use of the operation manifold 3. In particular, the use of a single manual valve 11 for the distribution line 7 and the filling line 8 of the tanks 4 is particularly advantageous, since it saves space, weight and the need for a manual valve. In addition, since the functional members are housed inside the body 6 of the operation manifold, the external appearance thereof is particularly uncluttered, with no or very few functional members forming projections outside the casing surface defined by the body 6 of the operation manifold 3. This thus optimizes the spatial footprint of the operation manifold 3. In the figures, in particular FIG. 4E, the functional members are shown schematically.

The advantages of the invention are particularly apparent when comparing a fluid storage and distribution assembly 1 according to the invention with a prior art fluid storage and distribution assembly 1′ as shown in FIG. 5. Components homologous to those of the invention are designated on FIG. 5 representing the prior art by the same numerical reference to which an apostrophe “′” has been added.

The fluid storage and distribution assembly 1′ of the prior art comprises an operation manifold 3′ comprising a body 6′ of generally elongated shape between two axial ends. The prior art operation manifold 3′ is attached to pressurized-fluid tanks 4′ via their end fittings 5′. The body 6′ comprises a filling line (not shown) for tanks 4′ and a distribution line (not shown) for distributing fluid stored in the tanks 4′. The filling line has a supply opening 18′ opening into an end face 13′ of the body 6′ of the operation manifold 3′. The distribution line has a distribution opening (not shown) opening into another end face of the body 6′ of the operation manifold 3′ which is axially opposite the end face 13′ into which the supply opening 18′ opens. The distribution line and the filling line each comprise a manual valve (not shown) designed to prevent or allow fluidic communication between the tanks and these respective lines. It is thus noted that a greater number of manual valves are used compared with the present invention.

The fluid storage and distribution assembly 1′ of the prior art comprises functional members which form projections from the outer surface of the body 6′ of the operation manifold 3′. In particular, FIG. 5 shows a thermo-controlled pressure relief device 25′ and a line 20′ for discharging fluid stored in the tanks 4′. These functional members are therefore not present in the body 6′ of the operation manifold 3′ and increase the spatial footprint thereof.

The following describes the operation of a pressurized-fluid storage and distribution assembly 1 for a vehicle 2 according to the invention.

A first step in using the fluid storage and distribution assembly 1 consists in filling the tanks 4 with pressurized fluid, that is, in this case, pressurized dihydrogen, using the operation manifold 3. To achieve this, the following steps are performed:
with the manual valve 11 open, the electrically operated valve 10 is closed or it is ensured that it is closed. In this way, the fluid can only circulate in the line 8 for filling the tanks 4; and
the tanks 4 are supplied with fluid, herein dihydrogen, from a fluid supply source. This supply takes place via the filling line 8 through, in order, the supply opening 18, the second particle filter 19, the second check valve 17, the manual valve 11, the communication openings 9 of the operation manifold 3 and, finally, the end fittings 5 of the various tanks 4. During this filling, the second check valve 17 prevents fluid from flowing back to the fluid supply source and the closed electrically operated valve 10 prevents fluid from flowing out of the operation manifold 3 towards the fluid consuming device, corresponding herein to a fuel cell.

Once the tanks 4 have been filled, the fluid, herein the dihydrogen, is used by the motor vehicle 2 as an energy source to power the fluid consuming member, herein the fuel cell, in order to generate electricity. A second step in using the fluid storage and distribution assembly 1 therefore consists in distributing the fluid stored in the tanks 4, herein the dihydrogen, to the consuming member of this fluid, herein the fuel cell, by means of the operation manifold 3. To achieve this, the following steps are performed:
opening the electrically operated valve 10 with the manual valve 11 open. In this way, the fluid can only circulate in the distribution line 7 for distributing fluid stored in the tanks 4; and
the fluid, herein the dihydrogen, is distributed from the tanks 4 to the fluid consuming member, herein the fuel cell. This distribution is possible because the electrically operated valve 10 and the manual valve 11 are open. This distribution takes place via the distribution line 7 through, in order, the end fittings 5 of the tanks 4, the communication openings 9 of the operation manifold 3, the manual valve 11, the first filter 16, the flow-limiting valve 15, the electrically operated valve 10, the first check valve 14 and the distribution opening 12. During this distribution, the first check valve 14 prevents fluid from flowing back towards the tanks 4 and the second check valve 17 prevents fluid from escaping via the supply opening 18 of the filling line 8 of the tanks 4.

Moreover, during the life of the fluid storage and distribution assembly 1, it is necessary to carry out various maintenance operations thereon, and in particular on the operation manifold 3. For several of these maintenance operations, it is necessary that the operation manifold 3 and the tanks 4 do not contain any fluid, that is, in this case, that they do not contain pressurized dihydrogen. To achieve this, it is necessary to discharge the fluid, in particular the fluid stored in the tanks, out of the tanks and out of the operation manifold 3. To achieve this, the following steps are performed:
the manual valve 11 is closed. There is then no risk of fluid escaping via the distribution opening 12 or the supply opening 18; and
the manual discharge valve 22 is opened. As the fluid is under pressure in the tanks 4 and the operation manifold 3, it naturally escapes from the tanks 4 and from the operation manifold 3 to the outside via the first line 20 for discharging fluid stored in the tanks 4 and the first discharge opening 21. In this way, the fluid can be easily discharged from the operation manifold 3 and from the tanks 4, and the operator can carry out the necessary maintenance operations.

The invention is not limited to the embodiments presented, and other embodiments will become clearly apparent to the person skilled in the art.

### List of References

1: vehicle pressurized-fluid storage and distribution assembly
2: motor vehicle
3: operation manifold
4: tank
5: tank end fitting
6: body of the operation manifold
6a: cap
6b: recess
6c: electrical connector
7: distribution line for fluid stored in the tanks
8: tank filling line
9: communication opening of the operation manifold
10: electrically operated valve
11: manual valve
12: distribution opening
13: end face of the operation manifold
14: first check valve
15: flow-limiting valve
16: first filter
17: second check valve
18: supply opening for the tank filling line
19: second particle filter
20: first line for discharging fluid stored in the tanks
21: first discharge opening
22: manual discharge valve
23: second line for discharging fluid stored in the tanks
24: second discharge opening
25: first thermo-controlled pressure relief device
26: third line for discharging fluid stored in the tanks
27: third discharge opening
28: second thermo-controlled pressure relief device
29: temperature sensor
30: pressure sensor

1. An operation manifold for a pressurized-fluid storage and distribution assembly for a vehicle, the assembly comprising a plurality of pressurized-fluid tanks, the operation manifold comprising:
a body having a plurality of communication openings, each communication opening being configured to be in fluidic communication with a tank,
an electrically operated valve,
a manual valve,
a fluid distribution line for distributing fluid stored in the tanks, the fluid distribution line being formed in the body and being configured to be in fluidic communication with the tanks via the electrically operated valve and the manual valve, the fluid distribution line comprising a first check valve designed to prevent fluid from flowing in a first direction towards the tanks and to allow fluid to flow in a second direction, opposite to the first direction,
a tanks filling line, formed in the body and configured to be in fluidic communication with the tanks, the tanks filling line comprising a second check valve designed to allow fluid to flow in the first direction towards the tanks and to prevent fluid from flowing in an opposite direction,
wherein the manual valve is also used to provide fluidic communication between the tanks filling line and the tanks.

2. The operation manifold according to claim 2, further comprising a first line for discharging fluid stored in the tanks, formed in the body of the operation manifold and designed to bring the inside of the tanks into fluidic communication with the outside, the first line for discharging fluid stored in the tanks comprising a manual discharge valve designed to allow or prevent fluidic communication between the inside of the tanks and the outside.

3. The operation manifold according to claim 1, further comprising a second line for discharging fluid stored in the tanks, formed in the body of the operation manifold and designed to bring the inside of the tanks into fluidic communication with the outside, the second line for discharging fluid stored in the tanks comprising a first thermo-controlled pressure relief device designed to allow or prevent fluidic communication between the inside of the tanks and the outside.

4. The operation manifold according to claim 3, further comprising a third line for discharging fluid stored in the tanks, formed in the body of the operation manifold and designed to bring the inside of the tanks into fluidic communication with the outside, the third line for discharging fluid stored in the tanks comprising a second thermo-controlled pressure relief device designed to allow or prevent fluidic communication between the inside of the tanks and the outside.

5. The operation manifold according to claim 1, further comprising a temperature sensor housed inside the body of the operation manifold for measuring a temperature of the fluid present in the operation manifold.

6. The operation manifold according to claim 1, further comprising a pressure sensor housed inside the body of the operation manifold for measuring a pressure inside the operation manifold.

7. The operation manifold according to claim 1, further comprising at least one particle filter located upstream or downstream of the manual valve.

8. The operation manifold according to claim 1, wherein the distribution line for distributing fluid stored in the tanks comprises a distribution opening opening into an end region of the body of the operation manifold, the filling line comprising a supply opening, distinct from the distribution opening, opening into the same end region of the operation manifold as the distribution opening.

9. The operation manifold according to claim 1, wherein the distribution line comprises a flow-limiting valve arranged between the electrically operated valve and the manual valve.

10. The operation manifold according to claim 1, wherein the body of the operation manifold is integral and made of a material suitable for use in pressurized gas circulation.

11. A pressurized-fluid storage and distribution assembly for a vehicle, comprising the operation manifold according to claim 1.

12. A motor vehicle, comprising the pressurized-fluid storage and distribution assembly according to claim 11.

13. A method of distributing pressurized fluid for a vehicle by the operation manifold according to claim 1, comprising the following steps:
a) the manual valve being opened, opening the electrically operated valve, and
b) distributing fluid from the tanks to a fluid consuming member via the distribution line.

14. A method of filling pressurized-fluid tanks by the operation manifold according to claim 1, comprising the following steps:
a) the manual valve being opened, closing the electrically operated valve, and b) supplying the tanks with fluid from a supply source of this fluid via the filling line.

15. A method of discharging fluid stored in pressurized-fluid tanks by the operation manifold according to claim 2, comprising the following steps:
a) closing the manual valve, and
b) opening the manual discharge valve.
